(19) United States
(12) Patent Application Publication
(10) Pub. No.: US 2026/0287514 A1
(43) Pub. Date: Sep. 24, 2026

(54) EXTERIOR INSPECTION DEVICE AND INSPECTION LIGHT CONTROL METHOD

(71) Applicant: SONY HONDA MOBILITY INC., Tokyo (JP)

(72) Inventors: Keishi SETODA, Tokyo (JP); Yosuke ENDO, Tokyo (JP)

(73) Assignee: SONY HONDA MOBILITY INC., Tokyo (JP)

(21) Appl. No.: 19/088,514

(22) Filed: Mar. 24, 2025

(51) Int. Cl. G01N 21/88

(52) U.S. Cl. CPC G01N 21/8806; G01N 2021/8835

(57) ABSTRACT

Provided is improving inspection accuracy of the exterior of a vehicle. An exterior inspection device includes a light source configured to project, onto at least a side surface of a vehicle, inspection light used for inspection of an exterior of the vehicle and having a color temperature and illuminance adjusted to a color of a body of the vehicle. The present technology can be applied to, for example, an exterior inspection device used for inspection of an exterior of a vehicle.

### BACKGROUND OF THE INVENTION

### Field of the Invention

The present technology relates to an exterior inspection device and an inspection light control method and, more particularly, to an exterior inspection device and an inspection light control method used for inspection of the exterior of a vehicle.

### Description of the Related Art

There has been proposed a technology for improving inspection accuracy of the exterior of a vehicle.

For example, there has been proposed an optical tunnel that irradiates a vehicle with indirect light obtained by reflecting, with an inner wall in a dome-shaped tunnel, light from a light source extending in the length direction along the inner wall (see, for example, U.S. Pat. No. 5,911,500).

For example, there has been proposed an optical panel booth that irradiates a vehicle in a booth with stripe-shaped pattern light in the horizontal direction or the vertical direction (see, for example, U.S. Pat. No. 5,436,726).

For example, there has been proposed to, in a planar stage on which a vehicle is installed, provide a mirror surface in a region smaller than an installation area of the vehicle such that the bottom surface of the vehicle can be inspected in a sealed photograph inspection booth in which the vehicle is photographed using indirect light (see, for example, US2024/0210799).

As explained above, there has been a demand for a technology for improving inspection accuracy of the exterior of a vehicle.

### SUMMARY OF THE INVENTION

The present technology has been devised in view of such circumstances and improves inspection accuracy of the exterior of a vehicle.

An exterior inspection device according to a first aspect of the present technology includes a light source configured to project, onto at least a side surface of a vehicle, inspection light used for inspection of an exterior of the vehicle and having a color temperature and illuminance adjusted to a color of a body of the vehicle.

An inspection light control method according to a second aspect of the present technology includes an information processing device controlling, according to a color of a body of a vehicle, a color temperature and illuminance of inspection light projected onto at least a side surface of the vehicle and used for inspection of an exterior of the vehicle.

In the first aspect of the present technology, inspection light used for inspection of the exterior of a vehicle and having a color temperature and illuminance adjusted to a color of a body of the vehicle is projected onto at least a side surface of the vehicle.

In the second aspect of the present technology, a color temperature and illuminance of inspection light projected onto at least a side surface of a vehicle and used for inspection of the exterior of the vehicle are controlled according to a color of a body of the vehicle.

According to the first aspect or the second aspect of the present technology, it is possible to improve inspection accuracy of the exterior of the vehicle.

### BRIEF DESCRIPTION OF THE DRAWINGS

FIG. 1 is a perspective view illustrating an embodiment of an exterior inspection device to which the present technology is applied;

FIG. 2 is a table illustrating specifications of the exterior inspection device;

FIG. 3 is a table illustrating evaluation results of a color temperature and illuminance of inspection light in the case in which a color of a body of a vehicle is white;

FIG. 4 is a table illustrating evaluation results of a color temperature and illuminance of the inspection light in the case in which the color of the body of the vehicle is gray;

FIG. 5 is a table illustrating evaluation results of a color temperature and illuminance of the inspection light in the case in which the color of the body of the vehicle is black;

FIG. 6 is a diagram for explaining a study result of a direction of stripes of painted surface inspection light;

FIG. 7 is a diagram illustrating an example of a spacing and a width of the stripes of the painted surface inspection light;

FIG. 8 is a diagram for explaining a study result of a direction of stripes of surface continuity inspection light;

FIG. 9 is a diagram illustrating an example of a spacing and a width of the stripes of the surface continuity inspection light;

FIG. 10 is a plan view schematically illustrating a work area of the exterior inspection device;

FIG. 11 is a right side view schematically illustrating a layout of an LED of the exterior inspection device;

FIG. 12 is a plane view schematically illustrating the layout of the LED of the exterior inspection device;

FIG. 13 is a front view schematically illustrating the layout of the LED of the exterior inspection device;

FIG. 14 is a front view schematically illustrating a layout of work areas of a painted surface inspection device; and

FIG. 15 is a diagram illustrating a configuration example of a computer.

### DETAILED DESCRIPTION OF THE INVENTION

A mode for implementing the present technology is explained below. The explanation is made in the following order.
1. Embodiment
2. Modifications
3. Others

### 1. Embodiment

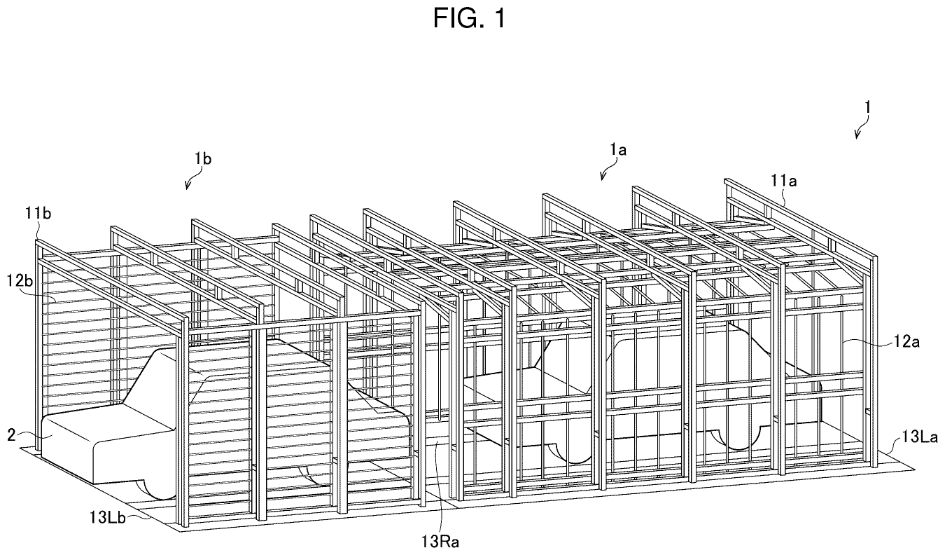

An embodiment of the present technology is explained with reference to FIGS. 1 to 14.

### Configuration Example of an Exterior Inspection Device 1

FIG. 1 illustrates an embodiment of an exterior inspection device 1 to which the present technology is applied.

The exterior inspection device 1 is a device in which an exterior inspection process for visually inspecting the exterior of a vehicle 2 is executed in a manufacturing line of the vehicle 2.

Note that, in the following explanation, the front direction of the vehicle 2 in the figure is represented as the front direction of the exterior inspection device 1, the rear direction of the vehicle 2 in the figure is represented as the rear direction of the exterior inspection device 1, the left side of the vehicle 2 in the figure is represented as the left side of the exterior inspection device 1, and the right side of the vehicle 2 in the figure is represented as the right side of the exterior inspection device 1.

The exterior inspection process is, for example, a final process of the manufacturing line of the vehicle 2 and includes a painted surface inspection process and a surface continuity inspection process. The exterior inspection device 1 includes a painted surface inspection device 1a in which the painted surface inspection process is executed and a surface continuity inspection device 1b in which the surface continuity inspection process is executed. The painted surface inspection device 1a and the surface continuity inspection device 1b are disposed side by side in the front-rear direction.

The painted surface inspection process is a process for inspecting painting of the outer surface of the vehicle 2. For example, aesthetics and the like of reflection of a painted surface on the outer side of the vehicle 2 are inspected. The painted surface inspection process includes inspection items such as “flaws”, “dirt”, “burrs”, “stains”, “pinholes”, “undercoat flaws”, “grinding marks”, “peeling”, “skin”, “gloss”, “color difference”, “cissing”, and “sagging”.

The term “flaws” is an item for inspecting the presence or absence and the degree of a state of physical damages being applied to the painted surface.

The term “dirt” is an item for inspecting the presence or absence and the degree of dust and foreign matter adhering during painting.

The term “burrs” is an item for inspecting the presence or absence of small protrusions and sharp remains that occurred on the painted surface.

The term “stains” is an item for inspecting the presence or absence of stains caused by tar of a drying furnace eroding painting and water drips from a ceiling entering a paint film.

The term “pinholes” is an item for inspecting the presence or absence and the degree of a phenomenon in which a solvent contained in the paint film (a paint) suddenly dries and remains in a bubble state and small holes are formed.

The term “undercoat flaws” is an item for inspecting the presence or absence and the degree of a painting failure due to the influence of an undercoat (grinding marks of the undercoat), correction marks of press deformation, scraping marks of welding spatter, and the like.

The term “grinding marks” is an item for inspecting the presence or absence of grinding marks that occur if paper sanding such as correction is not enough.

The term “peeling” is an item for inspecting the presence or absence of peeling of the painting.

The term “gloss” is an item for inspecting the degree of discomfort due to subtle unevenness of the painted surface.

The term “skin” is an item for inspecting the degree of discomfort of reflection of light on the painted surface.

The term “color difference” is an item for inspecting the degree of a difference in a color of the painted surface.

The term “cissing” is an item for inspecting the presence or absence of a phenomenon in which the painting is repelled, the paint film is pushed aside, and a recess occurs.

The term “sagging” is an item for inspecting the presence or absence of a phenomenon in which the painting drips to be nonuniform.

The surface continuity inspection process is a process for inspecting continuity (surface continuity) of the outer surface of the vehicle 2. For example, whether exterior panels (a body, doors, a fender, a bumper, and the like) of the vehicle 2 are smoothly connected to form a design having a sense of unity is inspected as the surface continuity. The painted surface inspection process includes inspection items such as “HEM”, “DF”, “level difference”, “gap width”, “left-right difference”, “angle difference”, and “sharp edge”.

The term “HEM” is an item for inspecting the degree of flange caused by hemming of a door.

The term “DF” is an item for inspecting the degree of deformation of the exterior.

The term “level difference” is an item for inspecting the degree of a level difference in a joining portion of a door or the like.

The term “gap width” is an item for inspecting the degree of a gap of the joining portion of the door or the like.

The term “left-right difference” is an item for inspecting the degree of a left-right difference of clearance gaps of the vehicle 2.

The term “angle difference” is an item for inspecting a parallelism of the clearance gaps of the vehicle 2.

The term “sharp edge” is an item for inspecting a sharp angle of the distal ends of the exterior panels.

The painted surface inspection device 1a includes a frame 11a, a plurality of LEDs 12a, and a work area 13La and a work area 13Ra.

The frame 11a includes a plurality of portal frames. The portal frames are disposed at predetermined spacings in the front-rear direction and cover, in the left-right direction, the sides and the top of the vehicle 2 disposed in the painted surface inspection device 1a. The portal frames are connected and reinforced by a plurality of beams extending in the front-rear direction.

The LEDs 12a respectively have trapezoidal portal shapes. That is, the LEDs 12a have portal shapes, upper corners of which are aslant. The LEDs 12a are supported by the frame 11a, disposed at predetermined spacings in the front-rear direction, and cover, in the left-right direction, the sides and the top of the vehicle 2 disposed in the painted surface inspection device 1a.

A light source that projects stripe-shaped inspection light (hereinafter referred to as painted surface inspection light) in which rays covering the sides and the top of the vehicle 2 in the left-right direction are in line in the front-rear direction of the vehicle 2 is configured by the LEDs 12a. The painted surface inspection light changes to, on the side surface of the vehicle 2, stripe-shaped light in which the rays extending in the up-down direction (the longitudinal direction) are in line in the front-rear direction of the vehicle 2 and changes to, on the upper surface (for example, a hood, a roof, and a trunk lid) of the vehicle 2, stripe-shaped light in which the rays extending in the left-right direction (the lateral direction) are in line in the front-rear direction of the vehicle 2. The painted surface inspection light is used for inspection of, among the inspection items of the painted surface inspection process explained above, “flaws”, “dirt”, “burrs”, “pinholes”, “undercoat flaws”, “grinding marks”, “skin”, “gloss”, “cissing”, and “sagging”.

Note that, for example, color temperatures and illuminances (luminances) of the LEDs 12a can be individually adjusted.

The work area 13La is provided, on the left side of the vehicle 2, on the floor surface to extend in the front-rear direction along the lower end on the left side of the frame 11a. The work area 13La includes, for example, a work bench including a mirror surface.

The work area 13Ra is provided, on the right side of the vehicle 2, on the floor surface to extend in the front-rear direction along the lower end on the right side of the frame 11a. The work area 13Ra includes, for example, a work bench including a mirror surface.

The surface continuity inspection device 1b includes a frame 11b, a plurality of LEDs 12b, and a work area 13Lb and a work area 13Rb.

The frame 11b includes a plurality of portal frames. The portal frames are disposed at predetermined spacings in the front-rear direction and cover, in the left-right direction, the sides and the top of the vehicle 2 disposed in the surface continuity inspection device 1b. The portal frames are connected and reinforced by a plurality of beams extending in the front-rear direction.

The LEDs 12b respectively have a linear shape extending in the horizontal direction. The LEDs 12b are disposed, on the left side surface and the right side surface on the inner side of the frame 11b, to extend in the front-rear direction and the horizontal direction at predetermined spacings in the up-down direction.

A light source that projects stripe-shaped inspection light (hereinafter referred to as surface continuity inspection light) in which rays extending in the front-rear direction of the vehicle 2 are in line in the up-down direction is configured by the LEDs 12b disposed on the left side surface on the inner side of the frame 11b. A light source that projects stripe-shaped inspection light (surface continuity inspection light) in which rays extending in the front-rear direction of the vehicle 2 are in line in the up-down direction is configured by the LEDs 12b disposed on the right side surface on the inner side of the frame 11b. The surface continuity inspection light is used for inspection of, among the inspection items of the surface continuity inspection process explained above, “HEM”, “DF”, “level difference”, and “gap width”.

Note that, for example, color temperatures and illuminances (luminances) of the LEDs 12b can be individually adjusted.

Therefore, the color temperature and the illuminance of the LEDs 12a of the painted surface inspection device 1a and the color temperature and the illuminance of the LEDs 12b of the surface continuity inspection device 1b can be independently adjusted.

The work area 13Lb is provided, on the left side of the vehicle 2, on the floor surface to extend in the front-rear direction along the lower end on the left side of the frame 11b. The work area 13 Lb includes, for example, a work bench.

The work area 13Rb is provided, on the right side of the vehicle 2, on the floor surface to extend in the front-rear direction along the lower end on the right side of the frame 11b. The work area 13Rb includes, for example, a work bench.

In the following explanation, when it is unnecessary to individually distinguish the frame 11a and the frame 11b, the frame 11a and the frame 11b are simply referred to as frame 11. In the following explanation, when it is unnecessary to individually distinguish the LEDs 12a and the LEDs 12b, the LEDs 12a and the LEDs 12b are simply referred to as LEDs 12. In the following explanation, when it is unnecessary to individually distinguish the work area 13La and the work area 13Ra, the work area 13La and the work area 13Ra are simply referred to as work area 13a. In the following explanation, when it is unnecessary to individually distinguish the work area 13Lb and the work area 13Rb, the work area 13Lb and the work area 13Rb are simply referred to as work area 13b. In the following explanation, when it is unnecessary to individually distinguish the work area 13La and the work area 13Lb, the work area 13La and the work are 13Lb are simply referred to as work area 13L. In the following explanation, when it is unnecessary to individually distinguish the work area 13Ra and the work area 13Rb, the work area 13Ra and the work area 13Rb are simply referred to as work area 13R. In the following explanation, when it is unnecessary to individually distinguish the work area 13La to the work area 13Rb, the work area 13La to the work area 13Rb are simply referred to as work area 13.

### Specifications of the Exterior Inspection Device 1

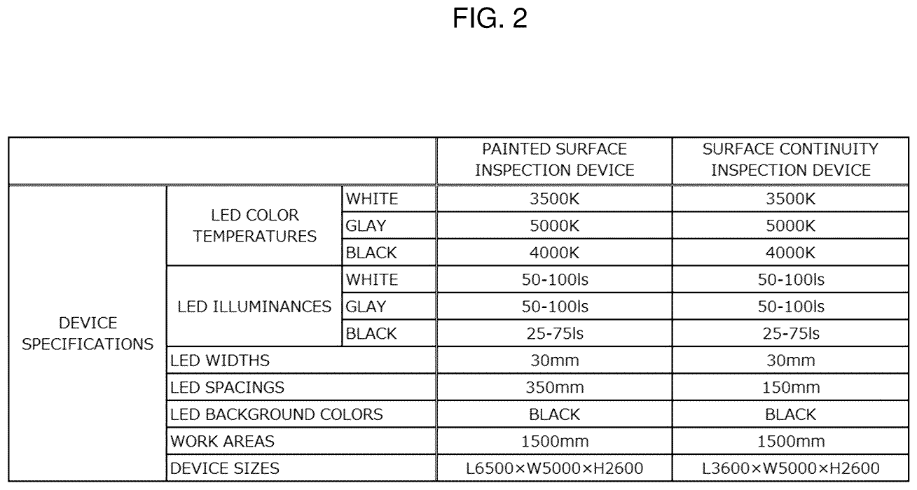

Subsequently, the specifications of the exterior inspection device 1 are explained with reference to FIGS. 2 to 14.

FIG. 2 is a table illustrating the specifications of the exterior inspection device 1. FIG. 2 illustrates color temperatures, illuminances, widths, spacings, and background colors of the LEDs 12, work areas, and the sizes of the painted surface inspection device 1a and the surface continuity inspection device 1b.

### Dolor Temperatures and Illuminances of the LEDs 12

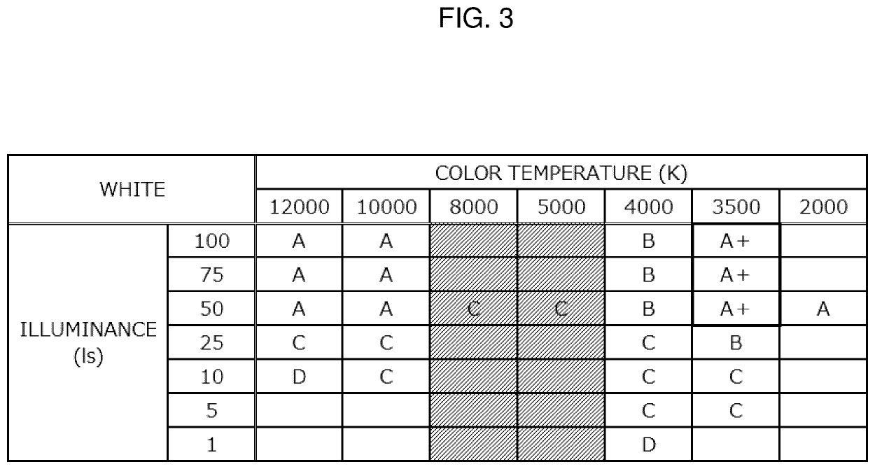

First, the color temperatures and the illuminances of the LEDs 12 of the painted surface inspection device 1a and the surface continuity inspection device 1b are explained with reference to FIGS. 3 to 5.

The color temperature and the illuminance of the LEDs 12 of the exterior inspection device 1 are adjusted according to a color of the body of the vehicle 2.

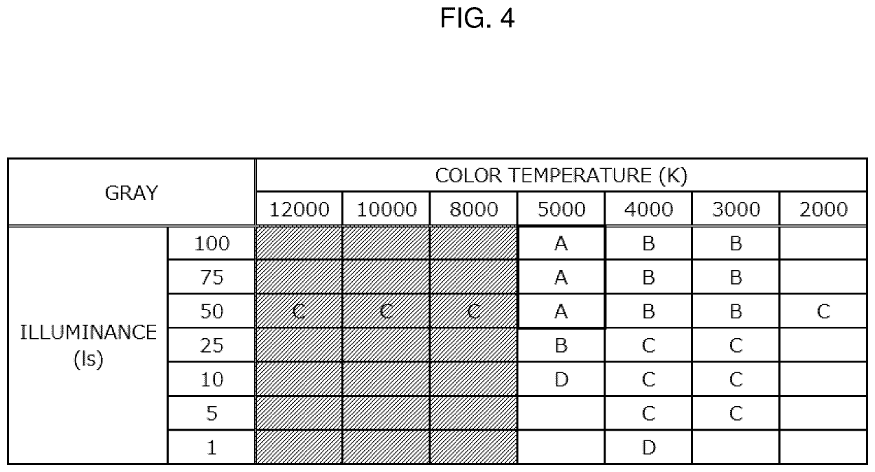

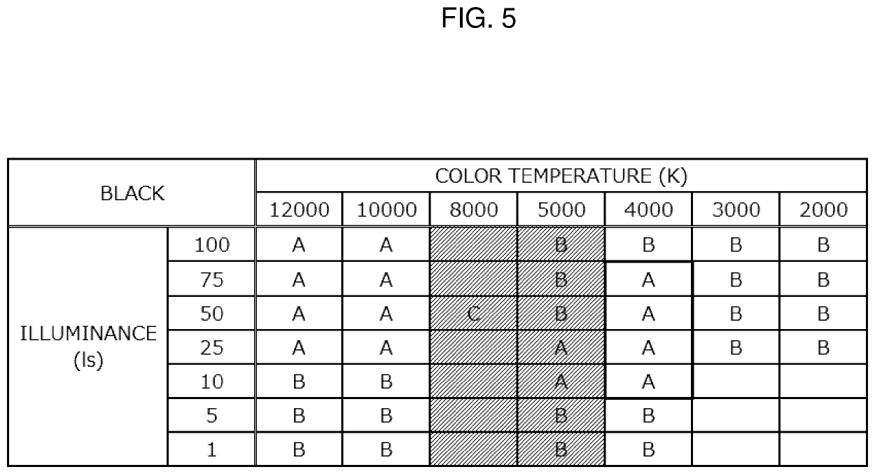

FIGS. 3 to 5 are tables illustrating evaluation results for combinations of the color temperature and the illuminances of the LEDs 12 in the case in which the color temperatures and the illuminances of the LEDs 12 were changed and a painted surface inspection and a surface continuity inspection of the vehicle 2 were executed. FIG. 3 illustrates evaluation results in the case in which the color of the body is white, FIG. 4 illustrates evaluation results in the case in which the color of the body is gray, and FIG. 5 illustrates evaluation results in the case in which the color of the body is black.

The table heads of the tables of FIGS. 3 to 5 indicate a color temperature (K (kelvin)) of the LEDs 12 and the table sides indicate illuminance (ls (lux)) per LED 12. Evaluations for combinations of color temperatures and illuminances are represented by A+, A, B , C, and D in order from the highest evaluation.

For example, when the color of the body is white, if the color temperature of the LEDs 12 is set to 5000 K to 8000 K, the color of the body and a color of inspection light are substantially the same and contrast of the inspection light to the color of the body decreases. For that reason, visibility to the inspection items of the painted surface inspection process and the surface continuity inspection process falls.

On the other hand, if the color temperature of the LEDs 12 is set to 4000 K or lower or 10000 K or higher, the contrast of the inspection light to the color of the body increases. For that reason, the visibility to the inspection items of the painted surface inspection process and the surface continuity inspection process rises.

However, when the color temperature of the LEDs 12 is lower than a certain level, human discomfort increases if the illuminance rises and, when the color temperature of the LEDs 12 is higher than a certain level, the human discomfort increases if the illuminance falls.

Therefore, for example, it is desirable to set the color temperature within the ranges of 2000 K to 4000 K and 10000 K to 12000 K and set the illuminance per LED 12 within a range of 50 ls to 100 ls. More specifically, when the color temperature is 2000 K, it is desirable to set the illuminance per LED 12 to 50 ls. For example, when the color temperature is 3500 K, it is desirable to set the illuminance per LED 12 to 25 ls to 100 ls, in particular, 50 ls to 100 ls. For example, when the color temperature is 10000 K, it is desirable to set the illuminance per LED 12 to 50 ls to 100 ls. For example, when the color temperature is 12000 K, it is desirable to set the illuminance per LED 12 to 50 ls to 100 ls.

Above all, if cost and acquisition easiness of LEDs, a burden on the eyes of an inspector, and the like are considered, it is optimum to set the color temperature to 3000 K and set the illuminance per LED 12 to 50 ls to 100 ls.

For example, when the color of the body is gray, if the color temperature of LEDs 12 is set to 2000 K or lower and 8000 K to 12000 K, the contrast of the inspection light to the color of the body decreases. For that reason, the visibility to the inspection items of the painted surface inspection process and the surface continuity inspection process falls.

On the other hand, if the color temperature of the LEDs 12 is set to 3000 K to 5000 K, the contrast of the inspection light to the color of the body increases. For that reason, the visibility to the inspection items of the painted surface inspection process and the surface continuity inspection process rises.

However, as explained above, when the color temperature of the LEDs 12 is lower than the certain level, the human discomfort increases if the illuminance rises and, when the color temperature of the LEDs 12 is higher than a certain level, the human discomfort increases as the illuminance falls.

Therefore, for example, it is desirable to set the color temperature within a range of 3500 K to 5000 K and set the illuminance per LED 12 within a range of 25 ls to 100 ls. More specifically, when the color temperature is 3000 K, it is desirable to set the illuminance per LED 12 to 50 ls to 100 ls. For example, when the color temperature is 4000 K, it is desirable to set the illuminance per LED 12 to 50 ls to 100 ls. For example, when the color temperature is 5000 K, it is desirable to set the illuminance per LED 12 to 25 ls to 100 ls, in particular, 50 ls to 100 ls.

Above all, it is optimum to set the color temperature to 5000 K and set the illuminance per LED 12 to 50 ls to 100 ls.

For example, when the color of the body is black, if the color temperature of the LEDs 12 is set to 5000 K to 8000 K, for example, contrast of dirt in the inspection light decreases. For that reason, visibility to the inspection item such as “dirt” falls.

On the other hand, if the color temperature of the LEDs 12 is set within a range of 2000 K to 4000 K or 10000 K to 12000 K, the contrast of the inspection light to the color of the body increases and the contrast of the dirt in the inspection light increases. For that reason, visibility to the inspection items of the painted surface inspection process and the surface continuity inspection process rises.

However, as explained above, when the color temperature of the LEDs 12 is lower than the certain level, the human discomfort increases if the illuminance rises and, when the color temperature of the LEDs 12 is higher than a certain level, the human discomfort increases if the illuminance falls.

Therefore, for example, it is desirable to set the color temperature within the ranges of 2000 K to 4000 K and 10000 K to 12000 K and set the illuminance per LED 12 within a range of 1 ls to 100 ls. More specifically, when the color temperature is 2000 K, it is desirable to set the illuminance per LED 12 to 25 ls to 100 ls. For example, when the color temperature is 3000 K, it is desirable to set the illuminance to 25 ls to 100 ls. For example, when the color temperature is 4000 K, it is desirable to set the illuminance per LED 12 to 1 ls to 100 ls, in particular, 10 ls to 75 ls. For example, when the color temperature is 10000 K, it is desirable to set the illuminance per LED 12 to 1 ls to 100 ls, in particular, 25 ls to 100 ls. For example, when the color temperature is 12000 K, it is desirable to set the illuminance per LED 12 to 1 ls to 100 ls, in particular, 25 ls to 100 ls.

Note that, for example, a combination of the color temperature and the illuminance may be changed between the painted surface inspection light and the surface continuity inspection light.

### Width and Disposition of the LEDs 12

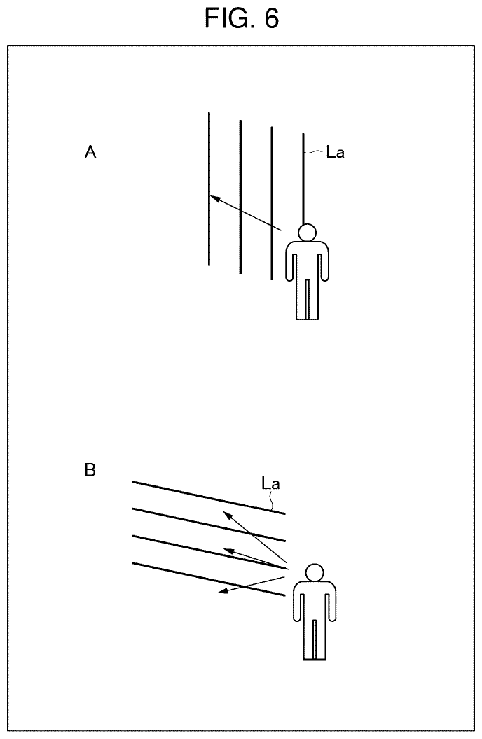

Subsequently, the width and the disposition of the LEDs 12 are explained with reference to FIGS. 6 to 9.

For example, in the painted surface inspection device 1a, when the LEDs 12a are disposed, in the up-down direction (longitudinally), side by side at equal spacings in the front-rear direction (the longitudinal direction) as schematically illustrated in A in FIG. 6, stripe-shaped painted surface inspection light La in the up-down direction (the longitudinal direction) is projected onto the side surface of the vehicle 2. In this case, if the inspector moves in the front-rear direction along the side surface of the vehicle 2, the position of the painted surface inspection light La viewed from the inspector shifts in the front-rear direction of the vehicle 2. Accordingly, simply by moving in the front-rear direction along the side surface of the vehicle 2, the inspector can inspect painting of the entire side surface of the vehicle 2 using the painted surface inspection light La.

For example, in the painted surface inspection device 1a, when the LEDs 12a are disposed, in the front-rear direction (horizontally), side by side at equal spacings in the up-down direction, as schematically illustrated in B in FIG. 6, stripe-shaped painted surface inspection light La in the front-rear direction (the horizontal direction) is projected onto the side surface of the vehicle 2. In this case, in order to inspect the painting of the entire side surface of the vehicle 2 using the painted surface inspection light La, the inspector needs to move in the front-rear direction along the side surface of the vehicle 2 while moving gaze in the up-down direction.

Therefore, in the painted surface inspection device 1a, considering workability of the inspector, as illustrated in FIG. 1, the LEDs 12a are directed in the up-down direction (the longitudinal direction) and disposed side by side at equal spacings in the front-rear direction.

If the spacings of stripes of the painted surface inspection light La are 60 mm or less on the side surface of the vehicle 2, the spacings are too narrow and the shadow of an inspector easily gets into an inspection point. On the other hand, if the spacings of the stripes of the painted surface inspection light La are 80 mm or more on the side surface of the vehicle 2, the spacings are too wide and an inspection point for which inspection is difficult arises unless the inspector turns the head to move the gaze.

Further, as the width of the stripe of the painted surface inspection light La decreases on the side surface of the vehicle 2, a change in the painted surface becomes clear and inspection accuracy is improved.

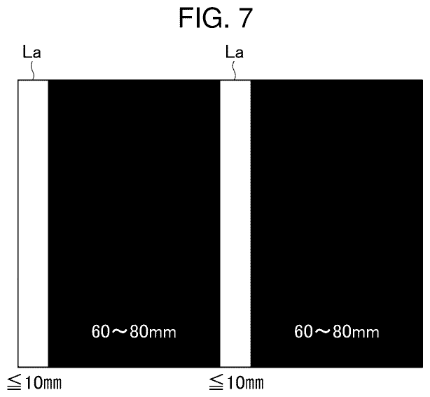

Therefore, as schematically illustrated in FIG. 7, the spacings of the stripes of the painted surface inspection light La on the side surface of the vehicle 2 are set in a range of 60 mm to 80 mm and the width of the stripe is set to 10 mm or less.

On the other hand, as explained below, a spacing between the LEDs 12a and the side surface of the vehicle 2 is set to approximately 1500 mm. In contrast, the width of the LED 12 a is set to 30 mm and a spacing between LEDs 12 a adjacent to each other is set to 350 mm to satisfy the conditions of the width of the stripe and the spacings of the stripes of the painted surface inspection light La in FIG. 7.

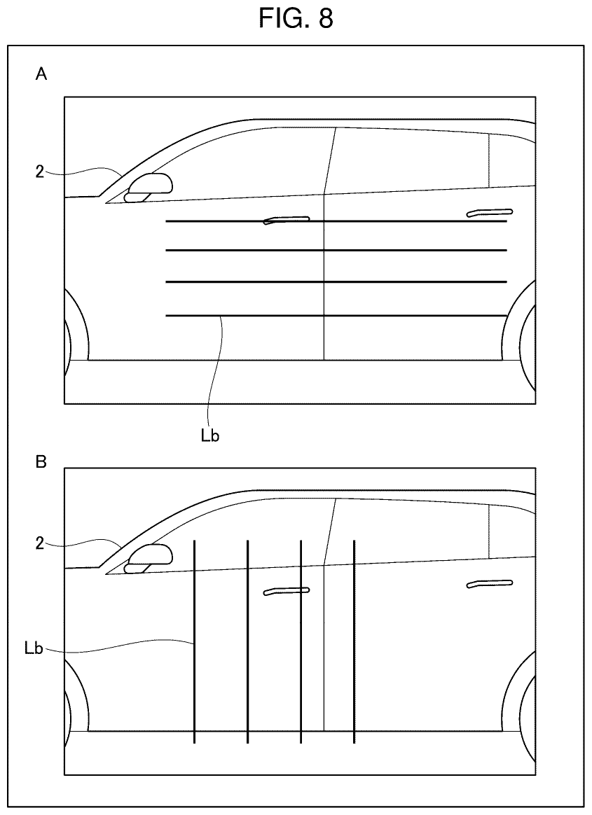

For example, in the surface continuity inspection device 1b, when the LEDs 12b are directed in the front-rear direction (horizontally) and disposed side by side at equal spacings in the up-down direction, as illustrated in A in FIG. 8, stripe-shaped surface continuity inspection light Lb in the front-rear direction (the horizontal direction) is projected onto the side surface of the vehicle 2. In this case, for example, visibility of level gaps of door sections of the vehicle 2 is improved by the surface continuity inspection light Lb and inspection accuracy of the level gaps is improved.

On the other hand, in the surface continuity inspection device 1b, when the LEDs 12b are directed in the up-down direction (longitudinally) and disposed side by side at equal spacings in the front-rear direction, as schematically illustrated in B in FIG. 8, stripe-shaped surface continuity inspection light Lb in the up-down direction (the longitudinal direction) is projected onto the side surface of the vehicle 2. In this case, for example, the level gaps of the door sections of the vehicle 2 cannot be seen with the surface continuity inspection light Lb and the inspection accuracy of the level gaps is deteriorated.

Therefore, in the surface continuity inspection device 1b, considering inspection accuracy of surface continuity, as illustrated in FIG. 1, the LEDs 12b are directed in the front-rear direction (the horizontal direction) and disposed side by side at equal spacings in the up-down direction.

If the intervals of the stripes of the surface continuity inspection light Lb are 20 mm or less on the side surface of the vehicle 2, even if the inspector does not bend and stretch, the inspector can inspect HEM and the like.

Further, as the width of the stripe of the surface continuity inspection light Lb decreases on the side surface of the vehicle 2, a change in the continuity of the side surface of the vehicle 2 becomes clear and inspection accuracy is improved.

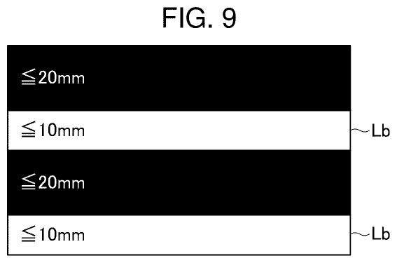

Therefore, as schematically illustrated in FIG. 9, the spacings of the stripes of the surface continuity inspection light Lb on the side surface of the vehicle 2 are set to 20 mm or less and the width of the stripe is set to 10 mm or less.

On the other hand, as explained below, a spacing between the LEDs 12b and the side surface of the vehicle 2 is set to approximately 1500 mm. In contrast, the width of the LED 12b is set to 30 mm and a spacing between LEDs 12b adjacent to each other is set to 150 mm to satisfy the conditions of the width of the stripe and the spacings of the stripes of the surface continuity inspection light Lb in FIG. 9.

Accordingly, accuracy of an exterior inspection of the vehicle 2 is improved.

For example, unevenness on the surface of the vehicle 2 is highlighted by a shade due to reflection of painted surface inspection light and “flaws” and “dirt” are easily detected. For example, when “skin” of the surface of the vehicle 2 is satisfactory, since the contours of stripes of the painted surface inspection light are clearly reflected, inspection accuracy of the “skin” is improved. For example, if “gloss” of the surface of the vehicle 2 is satisfactory, since a pattern of the LEDs 12a is projected in the painted surface inspection light, inspection accuracy of the “gloss” is improved.

For example, distortion of surface continuity inspection light is easily seen and inspection accuracy of “DF” and “HEM” is improved. For example, the presence or absence of linearity of the surface continuity inspection light becomes clear and inspection accuracy of “level difference” is improved.

### Background Color of the LEDs 12

Subsequently, a background color of the LEDs 12 is explained.

For example, if a background of the LEDs 12 (for example, light, a scene, or the like behind the LEDs 12) is reflected on the body of the vehicle 2 other than inspection light, it is likely that visibility to the body of the vehicle 2 is deteriorated to hinder inspection. Specifically, for example, when the frame 11 is made of aluminum, if the frame 11 is kept exposed, it is likely that the frame 11 is reflected on the body of the vehicle 2, visibility to the body of the vehicle 2 is deteriorated to hinder inspection.

In contrast, the frame 11 of the exterior inspection device 1 is painted in a dark color such as black. The background of the LEDs 12 is painted in a dark color such as black or covered with a wall, a curtain, or the like having a dark color such as black. Accordingly, the reflection of objects other than the inspection light on the body of the vehicle 2 is suppressed and workability and inspection accuracy are improved.

### Work Areas 13 of the Exterior Inspection Device 1

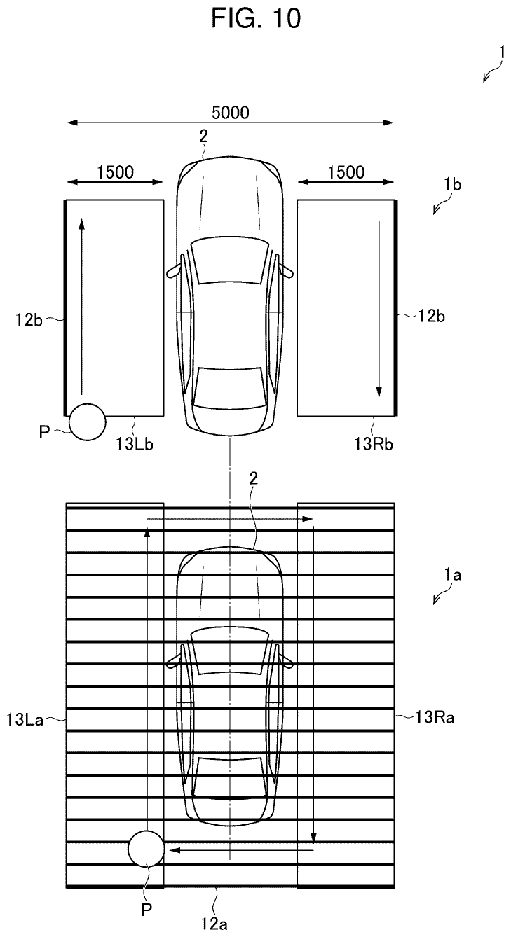

Subsequently, work areas 13 of the exterior inspection device 1 are explained with reference to FIG. 10.

FIG. 10 is a plan view schematically illustrating the work area 13La and the work area 13Ra of the painted surface inspection device 1 a and the work area 13 Lb and the work area 13Rb of the surface continuity inspection device 1b of the exterior inspection device 1.

The width in the left-right direction of the work area 13La and the work area 13Ra of the painted surface inspection device 1a is set to 1500 mm. An inspector P inspects painting of the outer surface (for example, the front surface, the side surface, and the rear surface) of the vehicle 2 while turning around positions approximately 500 mm separated from the periphery of the vehicle 2.

Like the width in the left-right direction of the work area 13La and the work area 13Ra of the painted surface inspection device 1a, the width in the left-right direction of the work area 13Lb and the work area 13Rb of the surface continuity inspection device 1b is set to 1500 mm. The inspector P inspects the continuity of the side surface of the vehicle 2 while moving, in the front direction or the rear direction, at positions approximately 1300 mm separated from the side surface of the vehicle 2.

### Layout of the Exterior Inspection Device 1

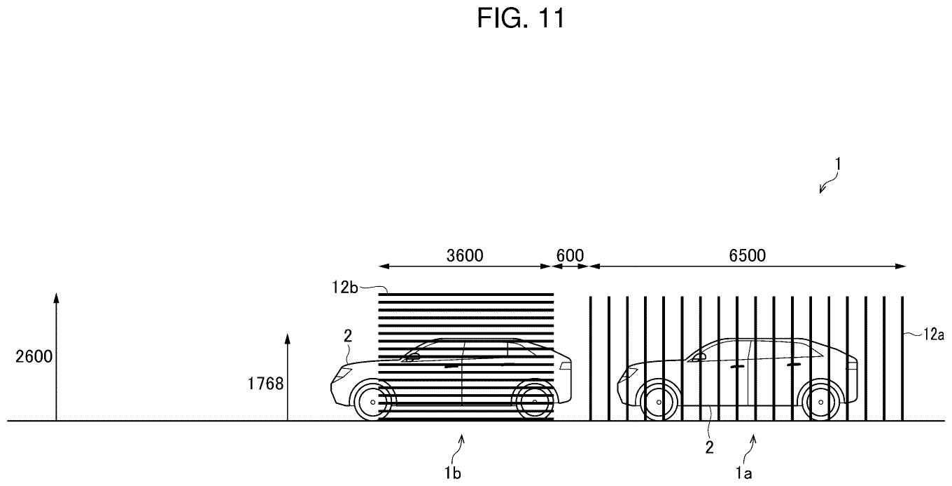

Subsequently, a layout of the exterior inspection device 1 (mainly, a layout of the LEDs 12) is explained with reference to FIGS. 11 to 13.

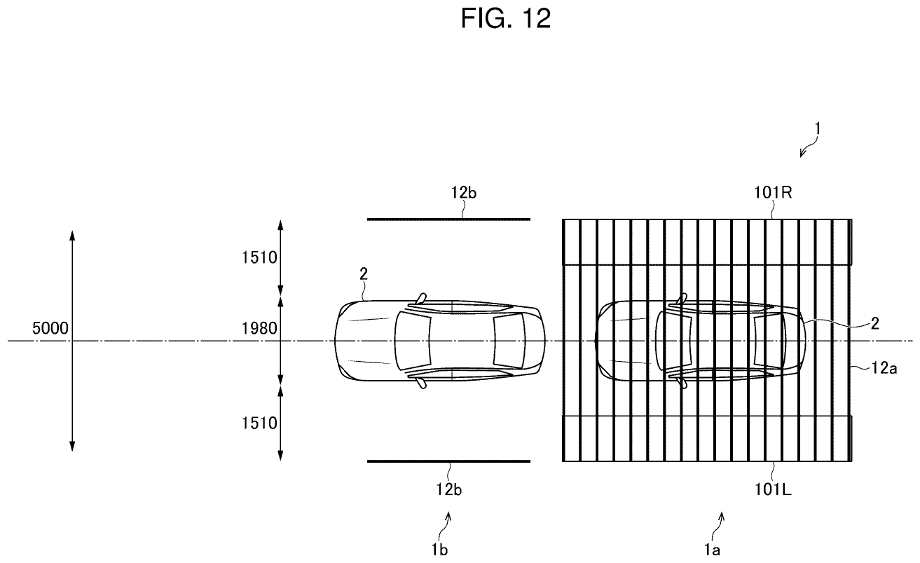

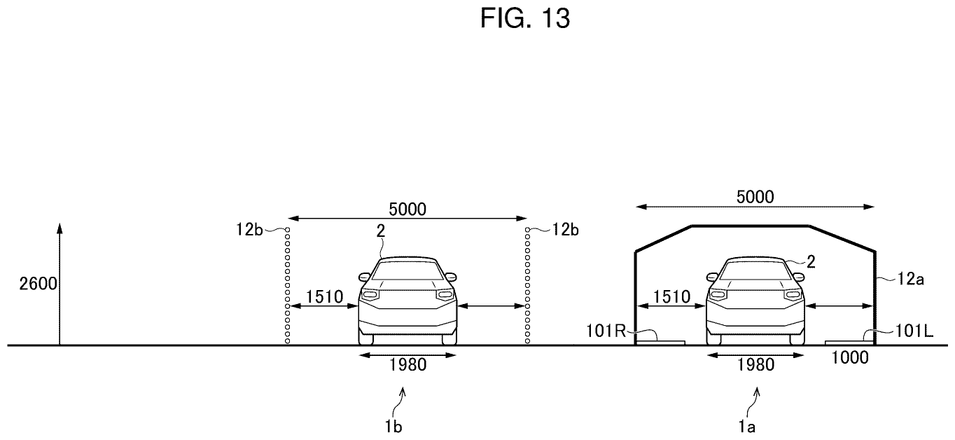

FIG. 11 is a left side view schematically illustrating the layout of the LEDs 12 of the exterior inspection device 1. FIG. 12 is a plan view schematically illustrating the layout of the LEDs 12 of the exterior inspection device 1. FIG. 13 is a front view individually schematically illustrating a layout of the LEDs 12a of the painted surface inspection device 1a and a layout of the LEDs 12b of the surface continuity inspection device 1b.

The entire length in the front-rear direction of the exterior inspection device 1 is set to 10700 mm.

The length in the front-rear direction of the painted surface inspection device 1a is set to 6500 mm longer than the entire length of the vehicle 2. That is, the LEDs 12a are disposed at predetermined spacings within a range of 6500 mm in the front-rear direction. Accordingly, the painted surface inspection light is projected to the front end to the rear end of the vehicle 2.

The length in the front-rear direction of the surface continuity inspection device 1b is set to 3600 mm. That is, the length of the LEDs 12b is set to 3600 mm. This length is shorter than the entire length of the vehicle 2 and is larger than the length from the front end of the frontmost door to the rear end of the rearmost door on the side surface of the vehicle 2. This length is a length equal to or larger than the length necessary for, as the inspector moves in the front-rear direction, when viewed from the inspector, the surface continuity inspection light to be projected onto an entire range in which inspection of surface continuity is necessary.

Accordingly, it is possible to reduce the entire length of the surface continuity inspection device 1b and reduce the entire length of the exterior inspection device 1. It is possible to reduce costs of the LEDs 12b.

The length in the front-rear direction of the surface continuity inspection device 1b may be set larger than the entire length of the vehicle 2.

A spacing is provided between the painted surface inspection device 1a and the surface continuity inspection device 1b in the front-rear direction. This spacing is set to a distance at which inspection light of the painted surface inspection device 1a and inspection light of the surface continuity inspection device 1b do not interfere with each other. That is, the spacing is set to a distance at which the painted surface inspection light of the painted surface inspection device 1a is not reflected on the body of the vehicle 2 disposed in the surface continuity inspection device 1b and the surface continuity inspection light of the surface continuity inspection device 1b is not reflected on the vehicle 2 disposed in the painted surface inspection device 1a. Specifically, the spacing between the painted surface inspection device 1a and the surface continuity inspection device 1 b is set to 600 mm.

The width in the left-right direction of the exterior inspection device 1 (the painted surface inspection device 1a and the surface continuity inspection device 1b) is set to 5000 mm. This is the length necessary for ensuring, with respect to the vehicle 2 having the width of 1980 mm, the work area 13 having the width of 1500 mm on each of the left and the right of the vehicle 2.

The LEDs 12a of the painted surface inspection device 1a are disposed at predetermined spacings in the front-rear direction at a position 1510 mm separated from both the side surfaces of the vehicle 2. The LEDs 12b of the surface continuity inspection device 1b are disposed at predetermined spacings in the up-down direction at a position 1510 mm separated from both the side surfaces of the vehicle 2.

The height of the exterior inspection device 1 (the painted surface inspection device 1a and the surface continuity inspection device 1 b) is set to 2600 mm higher than the vehicle 2 having the height of 1768 mm.

As illustrated in FIG. 13, the LEDs 12a of the painted surface inspection device 1a respectively have trapezoidal portal shapes. Vertical sections of the LEDs 12a extend in the up-down direction up to a position higher than the vehicle 2. Horizontal sections of the LEDs 12a extend in the left-right direction above the vehicle 2 and are wider than the width of the vehicle 2. The vertical sections and the horizontal sections of the LEDs 12 are connected by inclined sections in oblique directions.

Consequently, stripe-shaped painted surface inspection light extending in the up-down direction and the left-right direction of the vehicle 2 is projected to the front end to the rear end of the vehicle 2.

Note that the vertical sections, the inclined sections, and the horizontal sections of the LEDs 12a may be integrated or may be respectively configured by separate LEDs.

As illustrated in FIG. 13, the LEDs 12b of the surface continuity inspection device 1b are disposed up to a position higher than the vehicle 2.

Consequently, stripe-shaped surface continuity inspection light extending in the front-rear direction of the vehicle 2 is projected to the lower end to the upper end of the vehicle 2.

Here, in the painted surface inspection device 1a, only with the LEDS 12a, the painted surface inspection light is sometimes less easily projected to a lower part of the side surface of the vehicle 2.

In contrast, a mirror surface 101L configured by a mirror is installed on the floor surface of the work area 13La of the painted surface inspection device 1a and a mirror surface 101R configured by a mirror is installed on the floor surface of the work area 13Lb of the painted surface inspection device 1a.

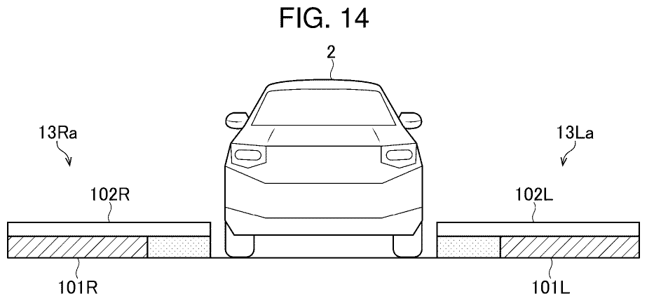

For example, as illustrated in FIGS. 13 and 14, the mirror surface 101L is installed, from the front end to the rear end of the work area 13La, at width of 1000 mm from the left end. As illustrated in FIG. 14, in order to protect the mirror surface 101L, the upper surface of the mirror surface 101L is covered by transparent reinforced plastic 102L.

Similarly, as illustrated in FIGS. 13 and 14, the mirror surface 101R is installed, from the front end to the rear end of the work area 13Ra, at the width of 1000 mm from the right end. As illustrated in FIG. 14, in order to protect the mirror surface 101R, the upper surface of the mirror surface 101R is covered by transparent reinforced plastic 102R.

In the following explanation, when it is unnecessary to individually distinguish the mirror surface 101L and the mirror surface 101R, the mirror surface 101L and the mirror surface 101R are simply referred to as mirror surface 101.

The painted surface inspection light emitted from the LEDs 12a is reflected by the mirror surface 101 and projected to a lower part of the side surface of the vehicle 2. Accordingly, inspection accuracy of a painted surface in the lower part of the side surface of the vehicle 2 is improved.

As explained above, it is possible to improve accuracy of the exterior inspection of the vehicle 2, that is, accuracy of the painted surface inspection and the surface continuity inspection.

### 2. Modifications

Modifications of the embodiment of the present technology explained above are explained below.

### Modifications Concerning the LEDs 12

For example, the LEDs 12a may have a shape other than the trapezoidal portal shape. For example, the LEDs 12a may have portal shapes without the inclined sections or the horizontal sections may not be connected.

For example, light emitting elements other than the LEDs may be used.

### Modifications Concerning the Specifications of the Exterior Inspection Device 1

The layout and the size of the exterior inspection device 1 explained above are examples and can be changed as appropriate, for example, according to the shape, the size, and the like of a vehicle or the like set as an inspection target.

For example, the alignment in the front-rear direction of the painted surface inspection device 1a and the surface continuity inspection device 1b may be opposite to each other.

For example, the painted surface inspection device 1a and the surface continuity inspection device 1b may not be divided and the painted surface inspection process and the surface continuity inspection process may be executed by the same inspection device without moving the vehicle 2. In this case, LEDs for the painted surface inspection process and LEDs for the surface continuity inspection process may be provided in the same inspection device and properly used for each of the processes. For example, the same LEDs may be able to switch and project the painted surface inspection light and the surface continuity inspection light. For example, grid-like inspection light obtained by combining the painted surface inspection light and the surface continuity inspection light may be projected using grid-like LEDs.

For example, the exterior inspection device 1 may be separately provided for each color of the body of the vehicle 2. In this case, color temperatures and illuminances of the LEDs 12 of the exterior inspection devices 1 are adjusted in advance according to colors of bodies of the vehicles 2 set as inspection targets.

For example, a color temperature and illuminance of the LEDs 12 of the exterior inspection device 1 may be adjusted according to a color of the body of the vehicle 2 set as the inspection target. In this case, for example, the inspector or the like may manually adjust the color temperature and the illuminance of the LEDs 12 or the color temperature and the illuminance of the LEDs 12 may be automatically adjusted according to the color of the body of the vehicle 2.

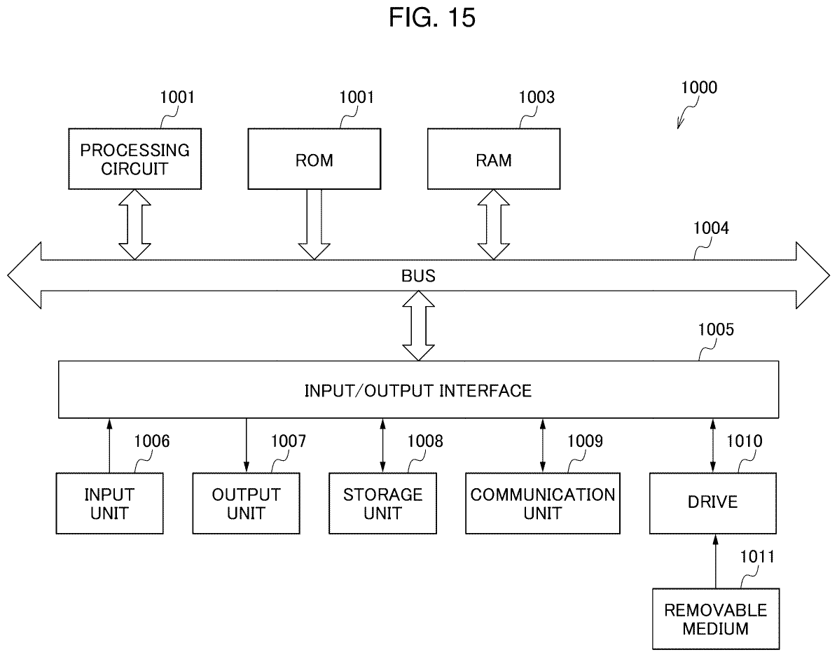

FIG. 15 is a block diagram illustrating a configuration example of hardware of a computer 1000 that controls a color temperature and illuminance of the LEDs 12 of the exterior inspection device 1.

The computer 1000 may be built in the exterior inspection device 1 or may be provided separately from the exterior inspection device 1.

In the computer 1000, a processing circuit 1001, a read only memory (ROM) 1002, and a random access memory (RAM) 1003 are connected to one another by a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 can include physical or virtual operation means that a user operates to input information such as a keyboard, a mouse, or a touch panel and can further include means with which the user inputs information by voice, gaze, or the like. Further, the input unit 1006 can include a sensor for inputting various physical quantities to the computer 1000. For example, the input unit 1006 can include a camera that images the vehicle 2.

The output unit 1007 can include means for presenting information to the user by stimulating the senses of the user such as a display, a speaker, or a haptics device. The storage unit 1008 is configured by a hard disk, a nonvolatile or volatile memory, or the like and stores various kinds of information (including programs). The communication unit 1009 is a network interface or the like and performs communication with the outside by wire or radio. The drive 1010 drives a removable medium 1011 such as a magnetic disk, an optical disk, a magnetooptical disk, or a semiconductor memory.

The processing circuit 1001 includes a processor that executes programs such as a central processing unit (CPU) or a digital signal processor (DSP). (The processor of) the processing circuit 1001 loads a program stored in the storage unit 1008 to the RAM 1003 via the input/output interface 1005 and the bus 1004 and executes the program to thereby perform a series of processing.

The program to be executed by the computer 1000 (the processing circuit 1001) can be provided by, for example, being recorded in a removable medium 1011 serving as a package medium or the like. The program can be provided via a wired or wireless transmission medium such as a local area network, the Internet, or a digital satellite broadcast.

For example, the processing circuit 1001 recognizes a color of the body of the vehicle 2 based on an image of the vehicle 2 captured by a camera or the like included in the input unit 1006. Alternatively, for example, the processing circuit 1001 recognizes a color of the body of the vehicle 2 based on information concerning a color of the vehicle 2 input by the inspector or the like via the input unit 1006. The processing circuit 1001 determines a color temperature and illuminance (or luminance) of the LEDs 12 based on the recognized color of the body of the vehicle 2. The processing circuit 1001 performs communication with the exterior inspection device 1 via the communication unit 1009 and sets a color temperature and illuminance (or luminance) of the LEDs 12.

### Application Examples of the Present Technology

In the present technology, a type and a size of a vehicle set as an inspection target are not particularly limited.

The present technology can also be applied to a case in which inspection of painting on the outer surface of equipment other than a vehicle and inspection of continuity of the outer surface is executed.

Embodiments of the present technology is not limited to the embodiment explained above and various changes are possible within a range not departing from the gist of the present technology.

Note that the effects described in the present specification are only exemplifications and are not limited. Other effects may be present.

### REFERENCE SIGNS LIST

1 Exterior inspection device, 1a Painted surface inspection device, 1b Surface continuity inspection device, 11a, 11b Frame, 12a, 12b LED, 13La to 13Rb Work space, 101L, 101R Mirror surface, 102L, 102R Reinforced plastic

1. An exterior inspection device comprising a light source configured to project, onto at least a side surface of a vehicle, inspection light used for inspection of an exterior of the vehicle and having a color temperature and illuminance adjusted to a color of a body of the vehicle.

2. The exterior inspection device according to claim 1, wherein the light source is capable of adjusting the color temperature and the illuminance of the inspection light according to the color of the body of the vehicle.

3. The exterior inspection device according to claim 2, further comprising a control unit configured to control the color temperature and the illuminance of the inspection light according to the color of the body of the vehicle.

4. The exterior inspection device according to claim 1, wherein
when the color of the body of the vehicle is white, the color temperature of the inspection light is within ranges of 2000 kelvin to 4000 kelvin and 10000 kelvin to 12000 kelvin and the illuminance of the inspection light is within a range of 25 lux to 100 lux,
when the color of the body of the vehicle is gray, the color temperature of the inspection light is within a range of 3500 kelvin to 5000 kelvin and the illuminance of the inspection light is within a range of 25 lux to 100 lux, and
when the color of the body of the vehicle is black, the color temperature of the inspection light is within ranges of 2000 kelvin to 4000 kelvin and 10000 kelvin to 12000 kelvin and the illuminance of the inspection light is within a range of 1 lux to 100 lux.

5. The exterior inspection device according to claim 4, wherein
when the color of the body of the vehicle is white, the color temperature of the inspection light is 3500 kelvin and the illuminance of the inspection light is within a range of 50 lux to 100 lux,
when the color of the body of the vehicle is gray, the color temperature of the inspection light is 5000 kelvin and the illuminance of the inspection light is within a range of 50 lux to 100 lux, and
when the color of the body of the vehicle is black, the color temperature of the inspection light is 4000 kelvin and the illuminance of the inspection light is within a range of 10 lux to 75 lux.

6. The exterior inspection device according to claim 1, wherein the inspection light includes stripe-shaped first inspection light extending in an up-down direction of the vehicle and stripe-shaped second inspection light extending in a front-rear direction of the vehicle.

7. The exterior inspection device according to claim 6, wherein the light source is capable of independently adjusting a color temperature and illuminance of the first inspection light and a color temperature and illuminance of the second inspection light.

8. The exterior inspection device according to claim 6, wherein the light source includes a first light source configured to project the first inspection light and a second light source configured to project the second inspection light.

9. The exterior inspection device according to claim 8, wherein
the first light source includes a plurality of first light emitting elements extending in the up-down direction,
the second light source includes a plurality of second light emitting elements extending in the front-rear direction of the vehicle,
the first light emitting elements are disposed, at a position separated from the side surface of the vehicle, at predetermined spacings in the front-rear direction of the vehicle, and
the second light emitting elements are disposed, at a position separated from the side surface of the vehicle, at predetermined spacings in the up-down direction.

10. The exterior inspection device according to claim 9, further comprising a mirror surface installed on a floor surface between the vehicle and the first light emitting elements and configured to reflect the first inspection light and project the inspection light onto at least the side surface of the vehicle.

11. The exterior inspection device according to claim 10, wherein the second light emitting elements are longer than a length from a front end of a frontmost door to a rear end of a rearmost door of the side surface of the vehicle and are shorter than an entire length of the vehicle.

12. The exterior inspection device according to claim 10, wherein the second light emitting elements are disposed up to a position higher than the vehicle.

13. The exterior inspection device according to claim 10, wherein the first light emitting elements extend in the up-down direction up to a position higher than the vehicle and are disposed in a range longer than an entire length of the vehicle.

14. The exterior inspection device according to claim 13, wherein the first light emitting elements further extend in a left-right direction of the vehicle above the vehicle.

15. The exterior inspection device according to claim 10, wherein frames supporting the first light emitting elements and the second light emitting elements and backgrounds of the first light emitting elements and the second light emitting elements are set to a dark color.

16. The exterior inspection device according to claim 9, further comprising:
a first inspection device including the first light source; and
a second inspection device including the second light source and disposed a spacing apart from the first inspection device in the front-rear direction of the vehicle.

17. The exterior inspection device according to claim 6, wherein
the first inspection light is used for inspection of painting of an outer surface of the vehicle, and
the second inspection light is used for inspection of continuity of the outer surface of the vehicle.

18. The exterior inspection device according to claim 6, wherein
a width of a stripe of the first inspection light on the side surface of the vehicle is 10 mm or less and a spacing between stripes is 60 mm to 80 mm, and
a width of a stripe of the second inspection light on the side surface of the vehicle is 10 mm or less and a spacing between stripes is 20 mm or less.

19. An inspection light control method comprising an information processing device controlling, according to a color of a body of a vehicle, a color temperature and illuminance of inspection light projected onto at least a side surface of the vehicle and used for inspection of an exterior of the vehicle.
